(19) United States
(12) Patent Application Publication
(10) Pub. No.: US 2022/0392352 A1
(43) Pub. Date: Dec. 8, 2022

(54) UNMANNED AERIAL VEHICLE MODULE MANAGEMENT

(71) Applicant: SKYGRID, LLC, Austin, TX (US)

(72) Inventors: SYED MOHAMMAD ALI, LEANDER, TX (US); LOWELL L. DUKE, AUSTIN, TX (US); ZEHRA AKBAR, LEANDER, TX (US); SYED MOHAMMAD AMIR HUSAIN, GEORGETOWN, TX (US); TAYLOR R. SCHMIDT, AUSTIN, TX (US); MILTON LOPEZ, ROUND ROCK, TX (US); RAVI TEJA PINNAMANENI, AUSTIN, TX (US)

(21) Appl. No.: 17/732,499

(22) Filed: Apr. 28, 2022

Related U.S. Application Data
(60) Provisional application No. 63/194,732, filed on May 28, 2021.

(51) Int. Cl. G08G 5/00; B64C 39/02

(52) U.S. Cl. CPC G08G 5/003; B64C 39/024; B64C 2201/126; B64C 2201/123

(57) ABSTRACT

Methods, systems, apparatuses, and computer program products for UAV module management are disclosed. In a particular embodiment, UAV module management includes software module library management by a computing system. In this embodiment, the computing system presents information representing a plurality of UAV software modules, receives information representing a UAV software module selection, and adds the UAV software module identified by the information representing a UAV software module selection to a UAV software module library. According to this embodiment, the computing system adds, based on a selection of a UAV software module, the selected UAV module to a UAV software module library.

### CROSS-REFERENCE TO RELATED APPLICATIONS

This application is a non-provisional application for patent entitled to a filing date and claiming the benefit of earlier-filed U.S. Provisional Patent Application Ser. No. 63/194,732, filed May 28, 2021, the contents of which are incorporated by reference herein in their entirety.

### BACKGROUND

An Unmanned Aerial Vehicle (UAV) is a term used to describe an aircraft with no pilot on-board the aircraft. The use of UAVs is growing in an unprecedented rate, and it is envisioned that UAVs will become commonly used for package delivery and passenger air taxis. However, as UAVs become more prevalent in the airspace, there is a need to regulate air traffic and ensure the safe navigation of the UAVs.

The Unmanned Aircraft System Traffic Management (UTM) is an initiative sponsored by the Federal Aviation Administration (FAA) to enable multiple beyond visual line-of-sight drone operations at low altitudes (under (400) feet above ground level (AGL) in airspace where FAA air traffic services are not provided. However, a framework that extends beyond the (400) feet AGL limit is needed. For example, unmanned aircraft that would be used by package delivery services and air taxis may need to travel at altitudes above (400) feet. Such a framework requires technology that will allow the FAA to safely regulate unmanned aircraft.

### SUMMARY

Methods, systems, apparatuses, and computer program products for UAV module management are disclosed. In a particular embodiment, UAV module management includes software module library management by a computing system. In this embodiment, the computing system presents information representing a plurality of UAV software modules, receives information representing a UAV software module selection, and adds the UAV software module identified by the information representing a UAV software module selection to a UAV software module library. According to this embodiment, the computing system adds, based on a selection of a UAV software module, the selected UAV module to a UAV software module library.

In a particular embodiment, UAV module management includes UAV software module management by a computing system. In this embodiment, the computing system presents information representing a plurality of UAV software modules of a UAV software library, receives information representing UAV software module selection from the plurality of UAV software modules of the UAV software module library, and transfers a UAV software module indicated by the UAV software module selection to a UAV memory. According to this embodiment, the computing system adds, based on a selection of a UAV software module, the selected UAV software module to a UAV memory.

In a particular embodiment, UAV module management includes UAV mission recommendations by a computing system. In this embodiment, the computing system receives at least one UAV mission parameter, determines at least one UAV software module dependent on the at least one UAV mission parameter, determines at least one UAV hardware configuration dependent on the at least one UAV mission parameter, and presents the at least one UAV software module and the at least one UAV hardware configuration. According to this embodiment, the computing system recommends UAV software modules and hardware configurations based on at least one UAV mission parameter.

The foregoing and other objects, features, and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a block diagram illustrating a particular implementation of a system for managing UAV software modules;

FIG. 2 is a block diagram illustrating a particular implementation of a system for managing UAV software modules;

FIG. 3A a block diagram illustrating a particular implementation of the blockchain used by the systems of FIGS. 1-2 to record data associated with an unmanned aerial vehicle;

FIG. 3B is an additional view of the blockchain of FIG. 3A;

FIG. 3C is an additional view of the blockchain of FIG. 3A;

FIG. 4 is a block diagram illustrating a particular implementation of a method for UAV software module library management;

FIG. 5 is a block diagram illustrating a particular implementation of a method for UAV software module library management;

FIG. 6 is a block diagram illustrating a particular implementation of a method for UAV software module library management;

FIG. 7 is a block diagram illustrating a particular implementation of a method for UAV software module management;

FIG. 8 is a block diagram illustrating a particular implementation of a method for UAV software module management;

FIG. 9 is a block diagram illustrating a particular implementation of a method for recommending UAV software modules and hardware configurations.

### DETAILED DESCRIPTION

Particular aspects of the present disclosure are described below with reference to the drawings. In the description, common features are designated by common reference numbers throughout the drawings. As used herein, various terminology is used for the purpose of describing particular implementations only and is not intended to be limiting. For example, the singular forms “a,” “an,” and “the” are intended to include the plural forms as well, unless the context clearly indicates otherwise. It may be further understood that the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signals) directly or indirectly, such as via one or more wires, buses, networks, etc. As used herein, “directly coupled” may include two devices that are coupled (e.g., communicatively coupled, electrically coupled, or physically coupled) without intervening components.

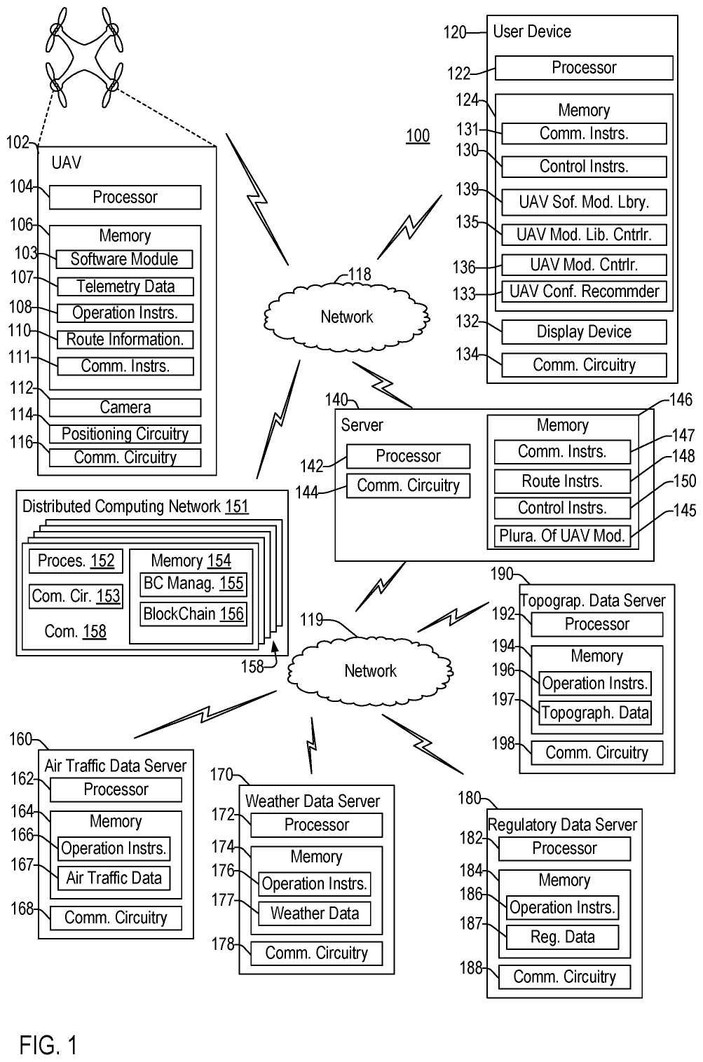

Exemplary methods, apparatuses, and computer program products for managing UAV software modules and UAV software module libraries in accordance with the present invention are described with reference to the accompanying drawings, beginning with FIG. 1. FIG. 1 sets forth a diagram of a system 100 configured for managing UAV software modules according to embodiments of the present disclosure. The system 100 of FIG. 1 includes an unmanned aerial vehicle (UAV) 102, a user device 120, a server 140, a distributed computing network 151, an air traffic data server 160, a weather data server 170, a regulatory data server 180, and a topographic data server 190.

A UAV, commonly known as a drone, is a type of powered aerial vehicle that does not carry a human operator and uses aerodynamic forces to provide vehicle lift. UAVs are a component of an unmanned aircraft system (UAS), which typically include at least a UAV, a control device, and a system of communications between the two. The flight of a UAV may operate with various levels of autonomy including under remote control by a human operator or autonomously by onboard or ground computers. Although a UAV may not include a human operator pilot, some UAVs, such as passenger drones (drone taxi, flying taxi, or pilotless helicopter) carry human passengers.

For ease of illustration, the UAV 102 is illustrated as one type of drone. However, any type of UAV may be used in accordance with embodiments of the present disclosure and unless otherwise noted, any reference to a UAV in this application is meant to encompass all types of UAVs. Readers of skill in the art will realize that the type of drone that is selected for a particular mission or excursion may depend on many factors, including but not limited to the type of payload that the UAV is required to carry, the distance that the UAV must travel to complete its assignment, and the types of terrain and obstacles that are anticipated during the assignment.

In FIG. 1, the UAV 102 includes a processor 104 coupled to a memory 106, a camera 112, positioning circuitry 114, and communication circuitry 116. The communication circuitry 116 includes a transmitter and a receiver or a combination thereof (e.g., a transceiver). In a particular implementation, the communication circuitry 116 (or the processor 104) is configured to encrypt outgoing message(s) using a private key associated with the UAV 102 and to decrypt incoming message(s) using a public key of a device (e.g., the user device 120 or the server 140 that sent the incoming message(s). As will be explained further below, the outgoing and incoming messages may be transaction messages that include information associated with the UAV. Thus, in this implementation, communications between the UAV 102, the user device 120, and the server 140 are secure and trustworthy (e.g., authenticated).

The camera 112 is configured to capture image(s), video, or both, and can be used as part of a computer vision system. For example, the camera 112 may capture images or video and provide the video or images to a pilot of the UAV 102 to aid with navigation. Additionally, or alternatively, the camera 112 may be configured to capture images or video to be used by the processor 104 during performance of one or more operations, such as a landing operation, a takeoff operation, or object/collision avoidance, as non-limiting examples. Although a single camera 112 is shown in FIG. 1, in alternative implementations more and/or different sensors may be used (e.g., infrared, LIDAR, SONAR, etc.).

The positioning circuitry 114 is configured to determine a position of the UAV 102 before, during, and/or after flight. For example, the positioning circuitry 114 may include a global positioning system (GPS) interface or sensor that determines GPS coordinates of the UAV 102. The positioning circuitry 114 may also include gyroscope(s), accelerometer(s), pressure sensor(s), other sensors, or a combination thereof, that may be used to determine the position of the UAV 102.

The processor 104 is configured to execute instructions stored in and retrieved from the memory 106 to perform various operations. For example, the instructions include operation instructions 108 that include instructions or code that cause the UAV 102 to perform flight control operations. The flight control operations may include any operations associated with causing the UAV to fly from an origin to a destination. For example, the flight control operations may include operations to cause the UAV to fly along a designated route (e.g., based on route information 110, as further described herein), to perform operations based on control data received from one or more control devices, to take off, land, hover, change altitude, change pitch/yaw/roll angles, or any other flight-related operations. The UAV 102 may include one or more actuators, such as one or more flight control actuators, one or more thrust actuators, etc., and execution of the operation instructions 108 may cause the processor 104 to control the one or more actuators to perform the flight control operations. The one or more actuators may include one or more electrical actuators, one or more magnetic actuators, one or more hydraulic actuators, one or more pneumatic actuators, one or more other actuators, or a combination thereof.

The route information 110 may indicate a flight path for the UAV 102 to follow. For example, the route information 110 may specify a starting point (e.g., an origin) and an ending point (e.g., a destination) for the UAV 102. Additionally, the route information may also indicate a plurality of waypoints, zones, areas, regions between the starting point and the ending point.

The route information 110 may also indicate a corresponding set of control devices for various points, zones, regions, areas of the flight path. The indicated sets of control devices may be associated with a pilot (and optionally one or more backup pilots) assigned to have control over the UAV 102 while the UAV 102 is in each zone. The route information 110 may also indicate time periods during which the UAV is scheduled to be in each of the zones (and thus time periods assigned to each pilot or set of pilots).

The memory 106 of the UAV 102 may also include communication instructions 111 that when executed by the processor 104 cause the processor 104 to transmit to the distributed computing network 151, transaction messages that include telemetry data 107. Telemetry data may include any information that could be useful to identifying the location of the UAV, the operating parameters of the UAV, or the status of the UAV. Examples of telemetry data include but are not limited to GPS coordinates, instrument readings (e.g., airspeed, altitude, altimeter, turn, heading, vertical speed, attitude, turn and slip), and operational readings (e.g., pressure gauge, fuel gauge, battery level).

In the example of FIG. 1, the memory 106 of the UAV 102 further includes at least one UAV software module 103. The UAV software module 103 is defined as a group of computer executable code that, when executed by a processor, enables at least one specialized functionality of a UAV that may not normally be present on the UAV. For example, in the embodiment of FIG. 1, the camera 112 may normally be configured to take pictures. The UAV software module 103 may be executed by processor 104 to enable additional functionality of the camera 112, such as object detection or tracking. The UAV software module 103 may work in conjunction with the existing hardware of the UAV 102, such as shown in FIG. 1, or in other examples, the UAV software module 103 may work in conjunction with optional hardware. For example, a UAV software module 103 may work in combination with a sensor not normally present on the UAV 102. In such examples, adding the sensor to the UAV 102 may only be enabled once the appropriate software module is enabled. Likewise, the UAV software module 103 may not be functional unless the additional sensor is present on the UAV 103. Examples of functionality that may be enabled by a software module include, but are not limited to, object detection, automated flight patterns, object tracking, object counting, or responses to object detection.

The user device 120 includes a processor 122 coupled to a memory 124, a display device 132, and communication circuitry 134. The display device 132 may be a liquid crystal display (LCD) screen, a touch screen, another type of display device, or a combination thereof. The communication circuitry 134 includes a transmitter and a receiver or a combination thereof (e.g., a transceiver). In a particular implementation, the communication circuitry 134 (or the processor 122 is configured to encrypt outgoing message(s) using a private key associated with the user device 120 and to decrypt incoming message(s) using a public key of a device (e.g., the UAV 102 or the server 140 that sent the incoming message(s). Thus, in this implementation, communication between the UAV 102, the user device 120, and the server 140 are secure and trustworthy (e.g., authenticated).

The processor 122 is configured to execute instructions from the memory 124 to perform various operations. The instructions include control instructions 130 that include instructions or code that cause the user device 120 to generate control data to transmit to the UAV 102 to enable the user device 120 to control one or more operations of the UAV 102 during a particular time period, as further described herein.

In the example of FIG. 1, the memory 124 of the user device 120 also includes communication instructions 131 that when executed by the processor 122 cause the processor 122 to transmit to the distributed computing network 151, messages that include control instructions 130 that are directed to the UAV 102. In a particular embodiment, the transaction messages are also transmitted to the UAV and the UAV takes action (e.g., adjusting flight operations), based on the information (e.g., control data) in the message.

In addition, the memory 124 of the user device 120 may also include a UAV software module library 139. The UAV software module library 139 includes at least one UAV software module, such as UAV software module 103, that enables a functionality of the UAV 102. Each UAV software module stored in the UAV software module library 139 may comprise computer executable instructions, that when executed by a processor, enable the UAV functionality. In some examples, the UAV software module may be executed by processor 122 of user device 120, or as described in relation to the UAV, the UAV software module may be executed by processor 104 of the UAV. In still another example, the UAV software module may execute on both the UAV 102 and the user device 120.

The memory 124 of the user device 120 may further include a UAV software module library controller 135. In a particular embodiment, the UAV software module library controller 135 includes instructions for management of the UAV software module library 139. The instructions, when executed by the processor 122 cause the processor 122 to carry out the operations of: presenting information representing a plurality of UAV software modules; receiving, from a user interacting with the user device 120, information representing a UAV software module selection from the plurality of UAV software modules; and adding a UAV software module identified by the information representing a UAV software module to the UAV software module library 139.

The memory 124 of the user device 120 may also include a UAV software module controller 136 that includes instructions for management of UAV software modules. The instructions, when executed by the processor 122, cause the processor 122 to carry out the operations of: presenting information representing a plurality of UAV software modules of the UAV software module library 139; receiving, from a user interacting with the user device 120, a selection of a UAV software module from the plurality of UAV software modules; and transferring a UAV software module indicated by the UAV software module selection to the UAV 102.

The memory 124 of the user device 120 may also include a UAV configuration recommender 133. The UAV configuration recommender 133 includes instructions for management of UAVs. The instructions, when executed by the processor 122, cause the processor 122 to carry out the operations of: receiving at least one UAV mission parameter; determining at least one UAV software module dependent on the at least one UAV mission parameter; determining at least one UAV hardware configuration dependent on the at least one UAV mission parameter; and presenting the at least one UAV software module and the at least one UAV hardware configuration.

The server 140 includes a processor 142 coupled to a memory 146, and communication circuitry 144. The communication circuitry 144 includes a transmitter and a receiver or a combination thereof (e.g., a transceiver). In a particular implementation, the communication circuitry 144 (or the processor 142 is configured to encrypt outgoing message(s) using a private key associated with the server 140 and to decrypt incoming message(s) using a public key of a device (e.g., the UAV 102 or the user device 120 that sent the incoming message(s). As will be explained further below, the outgoing and incoming messages may be transaction messages that include information associated with the UAV. Thus, in this implementation, communication between the UAV 102, the user device 120, and the server 140 are secure and trustworthy (e.g., authenticated).

The processor 142 is configured to execute instructions from the memory 146 to perform various operations. The instructions include route instructions 148 comprising computer program instructions for aggregating data from disparate data servers, virtualizing the data in a map, generating a cost model for paths traversed in the map, and autonomously selecting the optimal route for the UAV based on the cost model. For example, the route instructions 148 are configured to partition a map of a region into geographic cells, calculate a cost for each geographic cell, wherein the cost is a sum of a plurality of weighted factors, determine a plurality of flight paths for the UAV from a first location on the map to a second location on the map, wherein each flight path traverses a set of geographic cells, determine a cost for each flight path based on the total cost of the set of geographic cells traversed, and select, in dependence upon the total cost of each flight path, an optimal flight path from the plurality of flight paths. The route instructions 148 are further configured to obtain data from one or more data servers regarding one or more geographic cells, calculate, in dependence upon the received data, an updated cost for each geographic cell traversed by a current flight path, calculate a cost for each geographic cell traversed by at least one alternative flight path from the first location to the second location, determine that at least one alternative flight path has a total cost that is less than the total cost of the current flight path, and select a new optimal flight path from the at least one alternative flight paths. The route instructions 148 may also include instructions for storing the parameters of the selected optimal flight path as route information 110. For example, the route information may include waypoints marked by GPS coordinates, arrival times for waypoints, pilot assignments.

The instructions may also include control instructions 150 that include instructions or code that cause the server 140 to generate control data to transmit to the UAV 102 to enable the server 140 to control one or more operations of the UAV 102 during a particular time period, as further described herein.

In addition, the memory 146 of the server 140 may also include a plurality of UAV software modules 145. The plurality of UAV software modules 145 may be communicatively coupled with the UAV software module library controller 135 to provide a marketplace of UAV software modules, such as UAV software module 103. The plurality of UAV software modules 145 may further store a selected UAV software module and the UAV software module library controller 135 may transfer the selected UAV software module library 139.

In the example of FIG. 1, the memory 146 of the server 140 also includes communication instructions 147 that when executed by the processor 142 cause the processor 142 to transmit to the distributed computing network 151, transaction messages that include control instructions 150 that are directed to the UAV 102.

The distributed computing network 151 of FIG. 1 includes a plurality of computers. An example computer 158 of the plurality of computers is shown and includes a processor 152 coupled to a memory 154, and communication circuitry 153. The communication circuitry 153 includes a transmitter and a receiver or a combination thereof (e.g., a transceiver). In a particular implementation, the communication circuitry 153 (or the processor 152 is configured to encrypt outgoing message(s) using a private key associated with the computer 158 and to decrypt incoming message(s) using a public key of a device (e.g., the UAV 102, the user device 120, or the server 140 that sent the incoming message(s). As will be explained further below, the outgoing and incoming messages may be transaction messages that include information associated with the UAV 102. Thus, in this implementation, communication between the UAV 102, the user device 120, the server 140, and the distributed computing network 151 are secure and trustworthy (e.g., authenticated).

The processor 152 is configured to execute instructions from the memory 154 to perform various operations. The memory 154 includes a blockchain manager 155 that includes computer program instructions for utilizing an unmanned aerial vehicle for emergency response. Specifically, the blockchain manager 155 includes computer program instructions that when executed by the processor 152 cause the processor 152 to receive a transaction message associated with a UAV. For example, the blockchain manager may receive transaction messages from the UAV 102, the user device 120, or the server 140. The blockchain manager 155 also includes computer program instructions that when executed by the processor 152 cause the processor 152 to use the information within the transaction message to create a block of data; and store the created block of data in a blockchain data structure 156 associated with the UAV 102.

The blockchain manager may also include instructions for accessing information regarding an unmanned aerial vehicle (UAV). For example, the blockchain manager 155 also includes computer program instructions that when executed by the processor 152 cause the processor to receive from a device, a request for information regarding the UAV; in response to receiving the request, retrieve from a blockchain data structure associated with the UAV, data associated with the information requested; and based on the retrieved data, respond to the device.

The UAV 102, the user device 120, and the server 140 are communicatively coupled via a network 118. For example, the network 118 may include a satellite network or another type of network that enables wireless communication between the UAV 102, the user device 120, the server 140, and the distributed computing network 151. In an alternative implementation, the user device 120 and the server 140 communicate with the UAV 102 via separate networks (e.g., separate short-range networks.

In some situations, minimal (or no) manual control of the UAV 102 may be performed, and the UAV 102 may travel from the origin to the destination without incident. In some examples, a UAV software module may enable the minimal (or no) manual control operation of the UAV 102. However, in some situations, one or more pilots may control the UAV 102 during a time period, such as to perform object avoidance or to compensate for an improper UAV operation. In some situations, the UAV 102 may be temporarily stopped, such as during an emergency condition, for recharging, for refueling, to avoid adverse weather conditions, responsive to one or more status indicators from the UAV 102, etc. In some implementations, due to the unscheduled stop, the route information 110 may be updated (e.g., via a subsequent blockchain entry, as further described herein) by route instructions 148 executing on the UAV 102, the user device 120, or the server 140). The updated route information may include updated waypoints, updated time periods, and updated pilot assignments.

In a particular implementation, the route information is exchanged using a blockchain data structure. The blockchain data structure may be shared in a distributed manner across a plurality of devices of the system 100, such as the UAV 102, the user device 120, the server 140, and any other control devices or UAVs in the system 100. In a particular implementation, each of the devices of the system 100 stores an instance of the blockchain data structure in a local memory of the respective device. In other implementations, each of the devices of the system 100 stores a portion of the shared blockchain data structure and each portion is replicated across multiple of the devices of the system 100 in a manner that maintains security of the shared blockchain data structure as a public (i.e., available to other devices) and incorruptible (or tamper evident) ledger. Alternatively, as in FIG. 1, the blockchain data structure 156 is stored in a distributed manner in the distributed computing network 151.

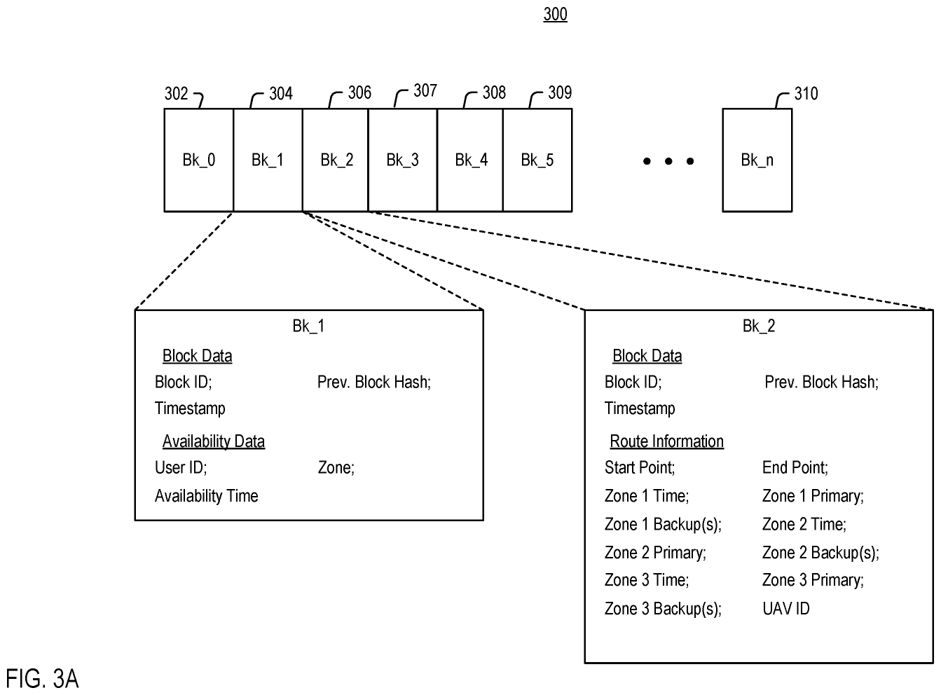

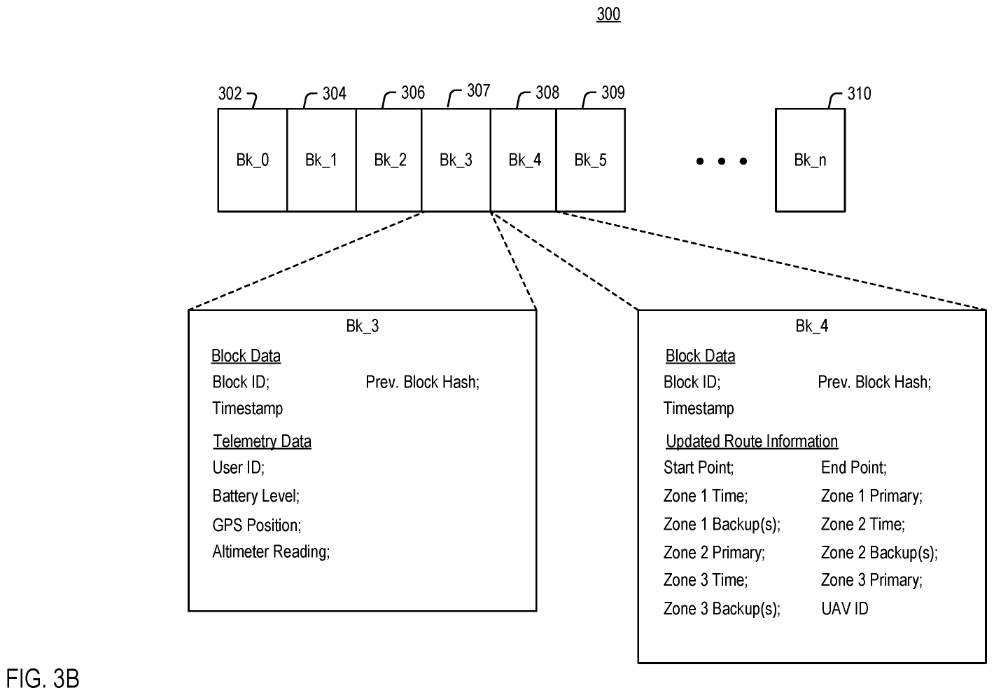

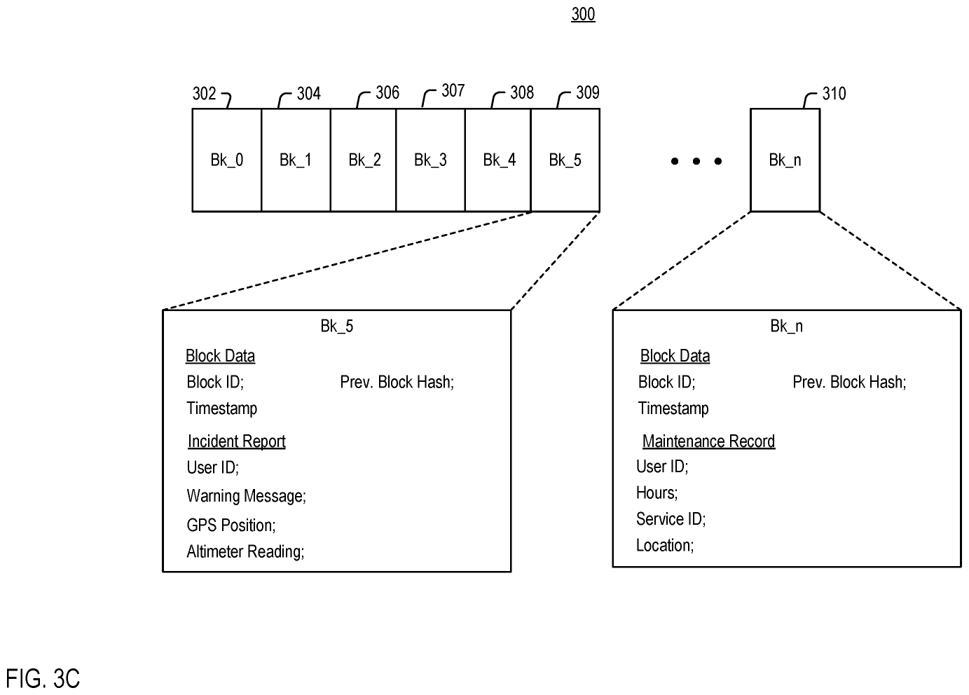

The blockchain data structure 156 may include, among other things, route information associated with the UAV 102, the telemetry data 107, the control instructions 130, and the route instructions 148. For example, the route information 110 may be used to generate blocks of the blockchain data structure 156. A sample blockchain data structure 300 is illustrated in FIGS. 3A-3C. Each block of the blockchain data structure 300 includes block data and other data, such as availability data, route data, telemetry data, service information, incident reports, etc.

The block data of each block includes information that identifies the block (e.g., a block ID) and enables the devices of the system 100 to confirm the integrity of the blockchain data structure 300. For example, the block data also includes a timestamp and a previous block hash. The timestamp indicates a time that the block was created. The block ID may include or correspond to a result of a hash function (e.g., a SHA (256) hash function, a RIPEMD hash function, etc.) based on the other information (e.g., the availability data or the route data) in the block and the previous block hash (e.g., the block ID of the previous block). For example, in FIG. 3A, the blockchain data structure 300 includes an initial block (Bk_0) 302 and several subsequent blocks, including a block Bk_1 304, a block Bk_2 306, a block BK_3 307, a block BK_4 308, a block BK_5 309, and a block Bk_n 310. The initial block Bk_0 302 includes an initial set of availability data or route data, a timestamp, and a hash value (e.g., a block ID) based on the initial set of availability data or route data. As shown in FIG. 1, the block Bk_1 304 also may include a hash value based on the other data of the block Bk_1 304 and the previous hash value from the initial block Bk_0 302. Similarly, the block Bk_2 306 other data and a hash value based on the other data of the block Bk_2 306 and the previous hash value from the block Bk_1 304. The block Bk_n 310 includes other data and a hash value based on the other data of the block Bk_n 310 and the hash value from the immediately prior block (e.g., a block Bk_n−1). This chained arrangement of hash values enables each block to be validated with respect to the entire blockchain; thus, tampering with or modifying values in any block of the blockchain is evident by calculating and verifying the hash value of the final block in the block chain. Accordingly, the blockchain acts as a tamper-evident public ledger of availability data and route data for the system 100.

In addition to the block data, each block of the blockchain data structure 300 includes some information associated with a UAV (e.g., availability data, route information, telemetry data, incident reports, updated route information, maintenance records, UAV software modules in use, etc.). For example, the block Bk_1 304 includes availability data that includes a user ID (e.g., an identifier of the mobile device, or the pilot, that generated the availability data), a zone (e.g., a zone at which the pilot will be available), and an availability time (e.g., a time period the pilot is available at the zone to pilot a UAV). As another example, the block Bk_2 306 includes route information that includes a UAV ID, a start point, an end point, waypoints, GPS coordinates, zone markings, time periods, primary pilot assignments, and backup pilot assignments for each zone associated with the route.

In the example of FIG. 3B, the block BK_3 307 includes telemetry data, such as a user ID (e.g., an identifier of the UAV that generated the telemetry data), a battery level of the UAV; a GPS position of the UAV; and an altimeter reading. As explained in FIG. 1, a UAV may include many types of information within the telemetry data that is transmitted to the blockchain managers of the computers within the distributed computing network 151. In a particular embodiment, the UAV is configured to periodically broadcast to the network 118, a transaction message that includes the UAV's current telemetry data. The blockchain managers of the distributed computing network receive the transaction message containing the telemetry data and store the telemetry data within the blockchain data structure 156.

FIG. 3B also depicts the block BK_4 308 as including updated route information having a start point, an endpoint, and a plurality of zone times and backups, along with a UAV ID. In a particular embodiment, the user device 120 or the server 140 may determine that the route of the UAV should be changed. For example, the control device or the server may detect that the route of the UAV conflicts with a route of another UAV or a developing weather pattern. As another example, the control device or the server many determine that the priority level or concerns of the user have changed and thus the route needs to be changed. In such instances, the control device or the server may transmit to the UAV, updated route information, control data, or navigation information. Transmitting the updated route information, control data, or navigation information to the UAV may include broadcasting a transaction message that includes the updated route information, control data, or navigation information to the network 118. The blockchain manager 155 in the distributed computing network 151, retrieves the transaction message from the network 118 and stores the information within the transaction message in the blockchain data structure 156.

FIG. 3C depicts the block BK_5 309 as including data describing an incident report. In the example of FIG. 3C, the incident report includes a user ID; a warning message; a GPS position; and an altimeter reading. In a particular embodiment, a UAV may transmit a transaction message that includes an incident report in response to the UAV experiencing an incident. For example, if during a flight mission, one of the UAV's propellers failed, a warning message describing the problem may be generated and transmitted as a transaction message.

FIG. 3C also depicts the block BK_n 310 that includes a maintenance record having a user ID of the service provider that serviced the UAV; flight hours that the UAV had flown when the service was performed; the service ID that indicates the type of service that was performed; and the location that the service was performed. UAV must be serviced periodically. When the UAV is serviced, the service provider may broadcast to the blockchain managers in the distributed computing network, a transaction message that includes service information, such as a maintenance record. Blockchain managers may receive the messages that include the maintenance record and store the information in the blockchain data structure. By storing the maintenance record in the blockchain data structure, a digital and immutable record or logbook of the UAV may be created. This type of record or logbook may be particularly useful to a regulatory agency and an owner/operator of the UAV.

Referring back to FIG. 1, in a particular embodiment, the server 140 may include a UAV software module that is configured to receive telemetry information from an airborne UAV and track the UAV's progress and status. The server 140 is also configured to transmit in-flight commands to the UAV 102. Operation of the user device 120 and the server 140 may be carried out by some combination of a human operator and autonomous software (e.g., artificial intelligence (AI) software that is able to perform some or all of the operational functions of a typical human operator pilot).

In a particular embodiment, the route instructions 148 cause the server 140 to plan a flight path, generate route information, dynamically reroute the flight path and update the route information based on data aggregated from a plurality of data servers. For example, the server 140 may receive air traffic data 167 over the network 119 from the air traffic data server 160, weather data 177 from the weather data server 170, regulatory data 187 from the regulatory data server 180, and topographical data 197 from the topographic data server 190. It will be recognized by those of skill in the art that other data servers useful in-flight path planning of a UAV may also provide data to the server 140 over the network 118 or through direct communication with the server 140. Additionally, communication with each data server may be enabled through the use of a UAV software module as described herein.

The air traffic data server 160 may include a processor 162, memory 164, and communication circuitry 168. The memory 164 of the air traffic data server 160 may include operating instructions 166 that when executed by the processor 162 cause the processor to provide the air traffic data 167 about the flight paths of other aircraft in a region, including those of other UAVs. The air traffic data may also include real-time radar data indicating the positions of other aircraft, including other UAVs, in the immediate vicinity or in the flight path of a particular UAV. Air traffic data servers may be, for example, radar stations, airport air traffic control systems, the FAA, UAV control systems, and so on.

The weather data server 170 may include a processor 172, memory 174, and communication circuitry 178. The memory 174 of the weather data server 170 may include operating instructions 176 that when executed by the processor 172 cause the processor to provide the weather data 177 that indicates information about atmospheric conditions along the UAV's flight path, such as temperature, wind, precipitation, lightening, humidity, atmospheric pressure, and so on. Weather data servers may be, for example, the National Weather Service (NWS), the National Oceanic and Atmospheric Administration (NOAA), local meteorologists, radar stations, other aircraft, and so on.

The regulatory data server 180 may include a processor 182, memory 184, and communication circuitry 188. The memory 184 of the weather data server 170 may include operating instructions 186 that when executed by the processor 182 cause the processor to provide the regulatory data 187 that indicates information about laws and regulations governing a particular region of airspace, such as airspace restrictions, municipal and state laws and regulations, permanent and temporary no-fly zones, and so on. Regulatory data servers may include, for example, the FAA, state and local governments, the Department of Defense, and so on.

The topographic data server 190 may include a processor 192, memory 194, and communication circuitry 198. The memory 194 of the topographic data server 190 may include operating instructions 196 that when executed by the processor 192 cause the processor to provide the topographical data that indicates information about terrain, places, structures, transportation, boundaries, hydrography, orthoimagery, land cover, elevation, and so on. Topographic data may be embodied in, for example, digital elevation model data, digital line graphs, and digital raster graphics. Topographic data servers may include, for example, the United States Geological Survey or other geographic information systems (GISs).

In some embodiments, the server 140 may aggregate data from the data servers 160, 170, 180, 190 using application program interfaces (APIs), syndicated feeds and eXtensible Markup Language (XML), natural language processing, JavaScript Object Notation (JSON) servers, or combinations thereof. Updated data may be pushed to the server 140 or may be pulled on-demand by the server 140. Notably, the FAA may be an important data server for both airspace data concerning flight paths and congestion as well as an important data server for regulatory data such as permanent and temporary airspace restrictions. For example, the FAA provides the Aeronautical Data Delivery Service (ADDS), the Aeronautical Product Release API (APRA), System Wide Information Management (SWIM), Special Use Airspace information, and Temporary Flight Restrictions (TFR) information, among other data. The National Weather Service (NWS) API allows access to forecasts, alerts, and observations, along with other weather data. The USGS Seamless Server provides geospatial data layers regarding places, structures, transportation, boundaries, hydrography, orthoimagery, land cover, and elevation. Readers of skill in the art will appreciate that various governmental and non-governmental entities may act as data servers and provide access to that data using APIs, JSON, XML, and other data formats.

Readers of skill in the art will realize that the server 140 can communicate with a UAV 102 using a variety of methods. For example, the UAV 102 may transmit and receive data using Cellular, 5G, Sub1GHz, SigFox, WiFi networks, or any other communication means that would occur to one of skill in the art.

The network 119 may comprise one or more Local Area Networks (LANs), Wide Area Networks (WANs), cellular networks, satellite networks, internets, intranets, or other networks and combinations thereof. The network 119 may comprise one or more wired connections, wireless connections, or combinations thereof.

The arrangement of servers and other devices making up the exemplary system illustrated in FIG. 1 are for explanation, not for limitation. Data processing systems useful according to various embodiments of the present disclosure may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), and others as will occur to those of skill in the art. Various embodiments of the present invention may be implemented on a variety of hardware platforms in addition to those illustrated in FIG. 1.

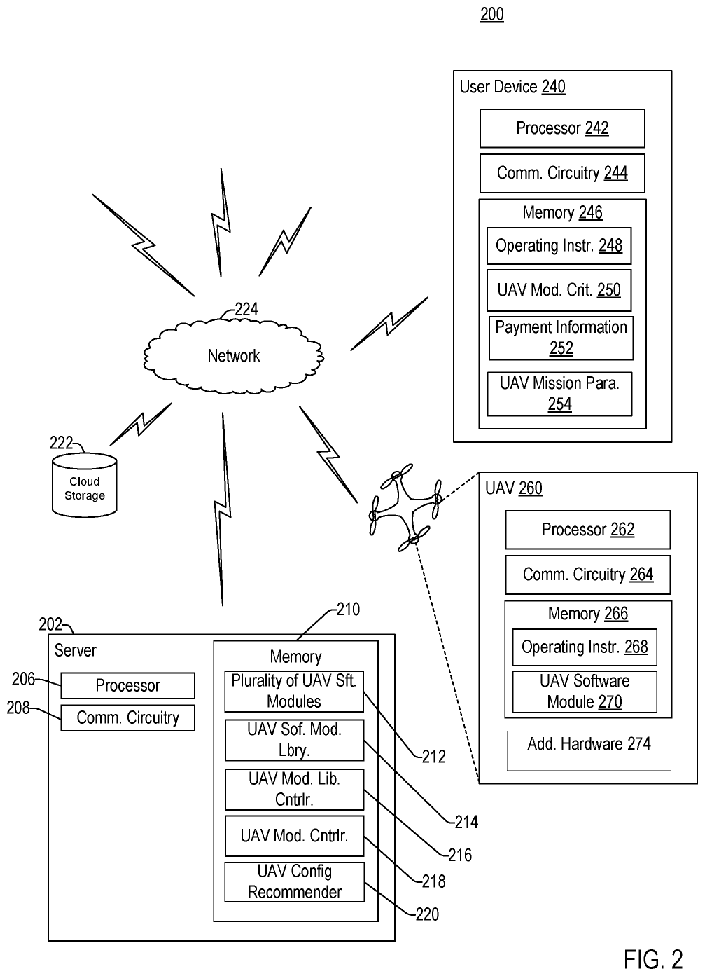

FIG. 2 is a block diagram illustrating a particular implementation of a system 200 for UAV software module management. The system 200 includes a server 202, a cloud storage 222, a user device 240, and a UAV 260. Each of the devices are configured to be communicatively coupled to one another over at least one network 224. While the system 200 is shown without a distributed computing network, topographic data server, regulatory data server, weather data server, and air traffic data server as described in relation to FIG. 1, these elements may be present in the example system of FIG. 2.

The server 202 includes a processor 206 coupled to communication circuitry 208 and memory 210. The memory 210 includes a plurality of UAV software modules 212, a UAV software module library 214, a UAV software module library controller 216, a UAV software module controller 218, and a UAV configuration recommender 220. The plurality of UAV software modules 212 may include UAV software modules that are available to add to a UAV software module library 214. In some examples, the plurality of UAV software modules 212 may include all UAV software modules available in a marketplace of UAV software modules. In some examples, the plurality of UAV software modules 212 may be stored remotely from the server 202 such as in cloud storage 222. The UAV software module library 214 includes UAV software modules that are associated with a particular UAV or a particular user. For example, the UAV software module library 214 may include all UAV software modules that a user has purchased or otherwise acquired. The user may be able to add a UAV software module from the UAV software module library 214 to any UAV associated with the user. In another example, the UAV software module library 214 may be specific to a UAV, such that any user may use a UAV software module for the UAV software module library 214 with the UAV. In some examples, the UAV software module library may be stored remotely from the server 202, such as in cloud storage 222.

The UAV software module library controller 216 is configured to manage the UAV software module library 214. For example, the server 202 may present to the user device 240 information representing the plurality of UAV software modules 212. In some examples, the server 202 may present the information to the user device 240 by way of an Application Program Interface (API) exposed by the server 202 to send the information representing the plurality of UAV software modules 212 to the user device 240, or may send a message (e.g., in the form of a transaction message) including the information representing a plurality of UAV software modules 212 to the user device 240. The user device 240 receives the information representing a plurality of UAV software modules 212 from the server 202 and may interact with a user to receive a selection of a UAV software module from the plurality of UAV software modules 212. The user device 240 may then send information representing the UAV software module selection to the server 202 and the server 202 receives the selection of the UAV software module. The server 202 may then add the selected UAV software module to the UAV software module library 214. For example, the server 202 may copy the selected UAV software module from the plurality of UAV software modules 212 to the UAV software module library.

The UAV software module controller 218 is configured to manage the UAV software modules associated with a user or a UAV. For example, the server 202 may present to the user device 240 information representing the UAV software module library 214. In some examples, the server 202 may present the information to the user device 240 by way of an Application Program Interface (API) exposed by the server 202 to send the information representing the UAV software module library 214 to the user device 240, or may send a message (e.g., in the form of a transaction message) including the information representing the UAV software module library 214 to the user device 240. The user device 240 receives the information representing the UAV software module library 214 from the server 202 and may interact with a user to receive a selection of a UAV software module from the UAV software module library 214. The user device 240 may then send information representing the selection to the server 202 with the server 202 receiving the selection of the UAV software module. The server 202 may then add the selected UAV software module to the UAV 260. For example, the server 202 may transfer the UAV software module to the UAV by way of network 224.

The UAV configuration recommender 220 is configured to recommend UAV software modules and UAV hardware configurations based on at least one mission parameter. For example, the UAV configuration recommender 220 may cause the server 202 to receive from the user device 240 information representing at least one UAV mission parameter 254. In some examples, the UAV configuration recommender 220 may receive the information representing the UAV mission parameter 254 by way of an Application Program Interface (API) exposed by the server 202 to the user device 240, or may receive a message (e.g., in the form of a transaction message) including the information representing the UAV mission parameter 254 from the user device 240. The UAV configuration recommender 220 may then cause the server 202 to determine at least one UAV software module from the UAV software module library 214 dependent on the at least one UAV mission parameter 254. The UAV configuration recommender 220 may further cause the server 202 to determine at least one UAV hardware configuration dependent on the at least one UAV mission parameter 254. The server 202 may then present the at least one UAV software module and the at least one UAV hardware configuration to the user device 240. In some examples, the server 202 may present the at least one UAV software module and the at least one UAV hardware configuration to the user device 240 by way of an Application Program Interface (API) exposed by the server 202 to send the information representing at least one UAV software module and the at least UAV hardware configuration to the user device 240, or may send a message (e.g., in the form of a transaction message) including the information representing the representing at least one UAV software module and the at least UAV hardware configuration to the user device 240.

The server 202 may be a general computing system that is used by a network client, such as user device 240, to process requests related to UAVs includes UAV pilots, UAV missions, and UAV mission history. In some examples, the server 202 may be incorporated in server 140, or distributed computing network 151 of FIG. 1.

The user device 240 includes a processor 242 coupled to communication circuitry 244 and memory 246. The memory 246 includes operating instructions 248 which are configured to provide an interface for interactions between a user and the server 202. The operating instructions may further cause the user device 240 to provide information presented by the server 202 to a user such as information representing the plurality of UAV software modules 212 and information representing the UAV software modules library 214. The operating instructions 248 may further cause the user device 240 to receive a selection from a user and provide information representing the selection to the server. Additionally, the operating instructions may receive information such as UAV software module criterion 250, payment information 252, and UAV mission parameters 254. For example, a user may interact with a user interface of the user device 240 to input a selection of UAV software module which may then be received by the user device 240 and provided to server 202 over network 424. In another example, a user may interact with the user interface of the user device 240 to input a UAV software module criterion 250 for filtering UAV software modules. In another example, a user may interact with the user interface of the user device 240 to input payment information 252 which may then be received by the user device 240 and provided to the server 202. In yet another example, the, a user may interact with the user interface of the user device 240 to input UAV mission parameters which may then be received by the user device 240 and provided to the server 202 over network 424.

The user device 240 can be any computing system configured to communicate with the server 202 to provide the user selection of a UAV software module, UAV software module criterion 250, payment information 252, or UAV mission parameters 254 to the server 202. Additionally, the user device 240 may be configured to display information presented to the user device 240 from the server such as information representing the plurality of UAV software modules, the UAV software module library 214, and the determined at least one software module and determined UAV hardware configuration. In some examples, the user device 240 may be a dedicated user device, or in other examples, the user device 240 can be a general-purpose computer executing a program for interaction with the server 202.

The UAV 260 includes a processor 262 coupled to communication circuitry 264 and the UAV memory 266. The UAV memory 266 includes operating instructions 268 which are configured to operate the UAV including communicating with the user device 240 and server 202 to receive flight controls. In addition, the UAV memory 266 includes at least one UAV software module 270 that enables a functionality of the UAV 260. The functionality may be independent of any additional hardware. For example, the UAV software module 270 may enable enhanced camera operation or enhanced automated flight operations. In other examples, the UAV software module 270 may enable additional hardware 274. For example, the UAV may have additional hardware 274 such as ground penetrating radar. The UAV software module 270 may provide instructions that cause the processor 262 and communication circuitry 264 to utilize the additional hardware 274. Thus, the additional hardware 274 may be inoperable without the UAV software module 270.

The following table gives examples of UAV software modules that may be used in combination with the described UAV software module management systems.

| | |
|---|---|
| Object Detection | Provides the use of an existing sensor or |
| | additional hardware to detect objects. |
| Object Tracking | Provides the use of existing sensor or |
| | additional hardware to track objects. |
| Autonomous Flight | Provides the use of existing or additional |
| | hardware to perform autonomous flight. |
| Reconnaissance | Provides the use of existing or additional |
| | hardware to observe a location. |
| Mapping | Provides the use of existing or additional |
| | hardware to map a location. |
| Fire Suppression | Provides the use of an existing or additional |
| | hardware to suppress fires. |
| Leak Detection | Provides the use of existing or additional |
| | hardware to detect leaks from objects. |
| Object Counting | Provides the use of existing or additional |
| | hardware to count objects. |
| UAV addons/features | Provides the use of additional hardware that is |
| | not otherwise operable with the operating |
| | instructions of the UAV. |

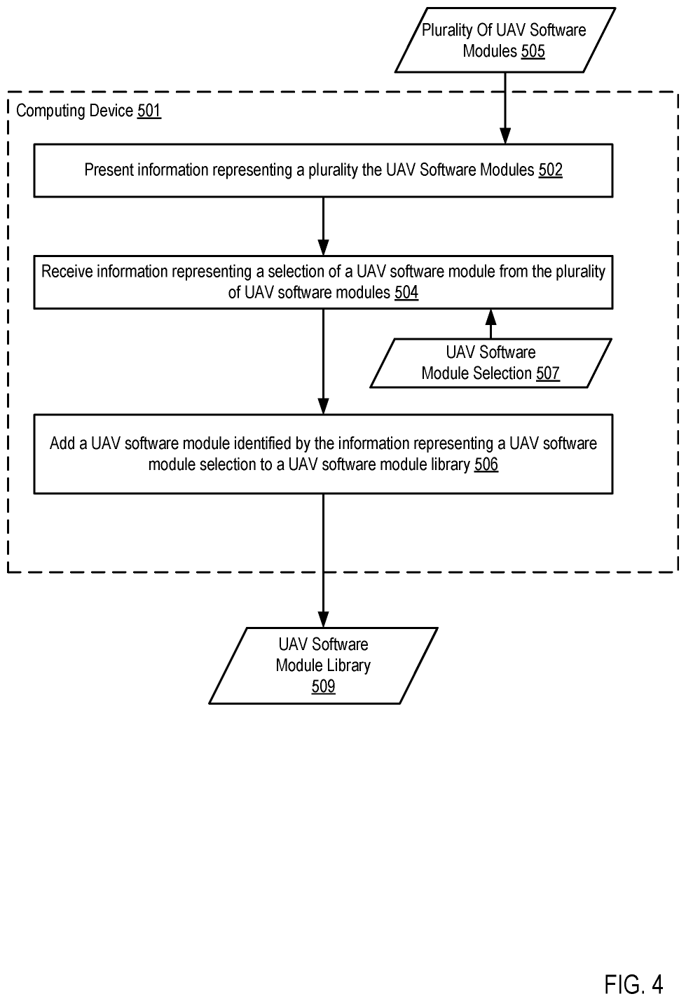

For further explanation, FIG. 4 sets forth a flow chart illustrating an exemplary method for UAV software module library management in accordance with at least one embodiment of the present disclosure. The method of FIG. 4 includes a computing system 501 of a UAV module management system such as the user device 120 of FIG. 1 or server 202 of FIG. 2. The method includes presenting 502, by the computing system 501, information representing a plurality of UAV software modules 505; receiving 504, by the computing system 501, information representing a UAV software module selection 507 from the plurality of UAV software modules 505; and adding 506 the UAV software module identified by the UAV software module selection 507 to a UAV software module library 509.

The computing system 501 may present 502 the information representing a plurality of UAV software modules 505 using the devices described in relation to FIG. 1 and FIG. 2. For example, referring to FIG. 1, the UAV software module library controller 135, may cause the user device 120 to display or otherwise present information representing the plurality of UAV software modules 505 to a user. In some examples, the user device 120 may display a list, a detailed list, icons, or other visual representation of the plurality of UAV software modules 505 to the user. In other examples, the plurality of UAV software modules 505 may be presented to a user using audio descriptions of each UAV software module.

Referring to FIG. 2, in another example, the UAV software module library controller 216 may cause the server 202 to present information representing the plurality of UAV software modules 505 to a user device 240. The user device 240 may then display or otherwise present the information representing the plurality of UAV software modules 505 to a user. The server 202 may present the information representing the plurality of UAV software modules 505 to the user device by way of a communicative coupling between the server 202 and the user device 240, such as network 424.

The computing system 501 may receive information representing a UAV software module selection 507 from the plurality of UAV software modules 505 using the devices described in relation to FIG. 1 and FIG. 2. For example, referring to FIG. 1, the UAV software module library controller 135 may cause the user device 120 to receive a selection of the UAV software module from the user interacting with the user device 120. The UAV software module selection 507 may be received by the user device 120 using common user interfaces, such as a touch input, keyboard input, voice recognition, mouse click, or other computer interaction.

In another example, referring to FIG. 2, the UAV software module library controller 216 may cause the server 202 to receive information indicating a UAV software module selection from the user device 240. The user device 240 may receive a UAV software module selection from a user interacting with the user device 240 using common user interfaces, such as a touch input, keyboard input, voice recognition, mouse click, or other computer interaction. The user device 240 may then send information representing the UAV software module selection 507 over network 224 for receipt by the server 202.

The computing system 501 may add 506 a UAV software module identified by the information representing a UAV software module selection 507 to a UAV software module library 509 using the devices described previously. In one example, referring to FIG. 1, the UAV software module library controller 135 may copy the UAV software module identified by the UAV software module selection 507 from the plurality of UAV software modules 145 to the UAV software module library 139. With reference to FIG. 2, in another example, the UAV software module library controller 216 may copy the UAV software module identified by the UAV software module selection 507 from the plurality of UAV software modules 212 to the UAV software module library 214.

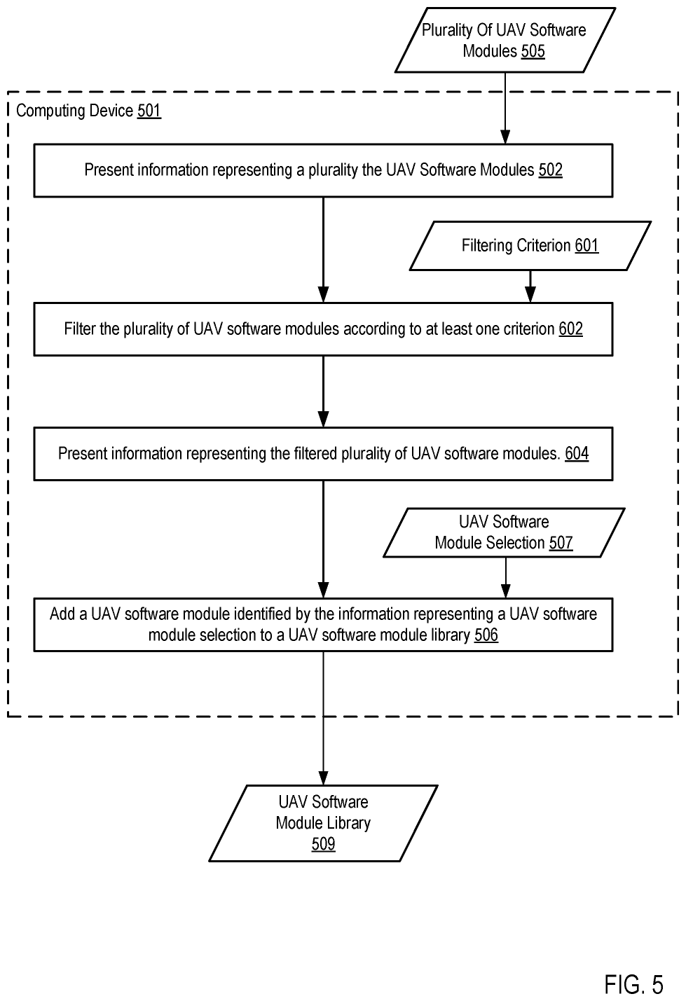

For further explanation, FIG. 5 sets forth a flow chart illustrating an exemplary method for UAV software module library management in accordance with at least one embodiment of the present disclosure. Like the exemplary method of FIG. 4, the exemplary method of FIG. 5 also includes presenting 502, by the computing system 501, information representing a plurality of UAV software modules 505; receiving 504, by the computing system 501, information representing a UAV software module selection 507 from the plurality of UAV software modules 505; and adding 506 the UAV software module identified by the UAV software module selection 507 to a UAV software module library 509.

The exemplary method of FIG. 5 differs from the method of FIG. 4 in that the method of FIG. 5 further comprises filtering 602, by the computing system 501, the plurality of UAV software modules 505 according to at least one filtering criterion 601 and presenting 604, by the computing system 501, information representing the filtered plurality of UAV software modules. In some examples, the filtering 602 the plurality of UAV software modules 505 according to at least one criterion may be carried out by the user device 120 of FIG. 1 or the server of 204 of FIG. 2. For example, a user may provide a filtering criterion 601 to the user device 120 by way of a user interface. The UAV software module library controller 135 may then filter the plurality of UAV software modules 505 and cause the user device 120 to present the filtered plurality of UAV software modules to the user. In another example, a user may provide a filtering criterion to user device 240 which may then communicate with server 202 by way of network 224 to deliver the filtering criterion 601 to the server 202. The server 202 may then filter the plurality of UAV software modules and present the filtered plurality of UAV software modules to the user device 240.

The filtering criterion 601 is a criterion that enables a user to narrow the plurality of UAV software modules. The filtering criterion 601 can include criteria such as an identification of a UAV model, an identification of a desired UAV software module, an identification of a UAV mission objective, pricing information for at least one UAV software module of the plurality of UAV software modules, or a hardware specification of the UAV. The following table provides an example list of criteria suitable for use in filtering the list and how the filtering may be implemented.

| Criteria | Implementation |
|---|---|
| UAV Model | Filter the plurality of UAV software modules to include |
| | UAV software modules compatible with the UAV model. |
| UAV Software | Filter the plurality of UAV software modules to include |
| Module | UAV software modules related to a specific software |
| | module. |
| UAV Software | Filter the plurality of UAV software modules to include |
| Module Price | UAV software modules within a specific price range. |
| UAV Hardware | Filter the plurality of UAV software modules to include |
| Specification | UAV software modules compatible with specific |
| | hardware. |
| UAV Mission | Filter the plurality of UAV software modules to include |
| Objective | software modules related to a particular mission |
| | objective. |

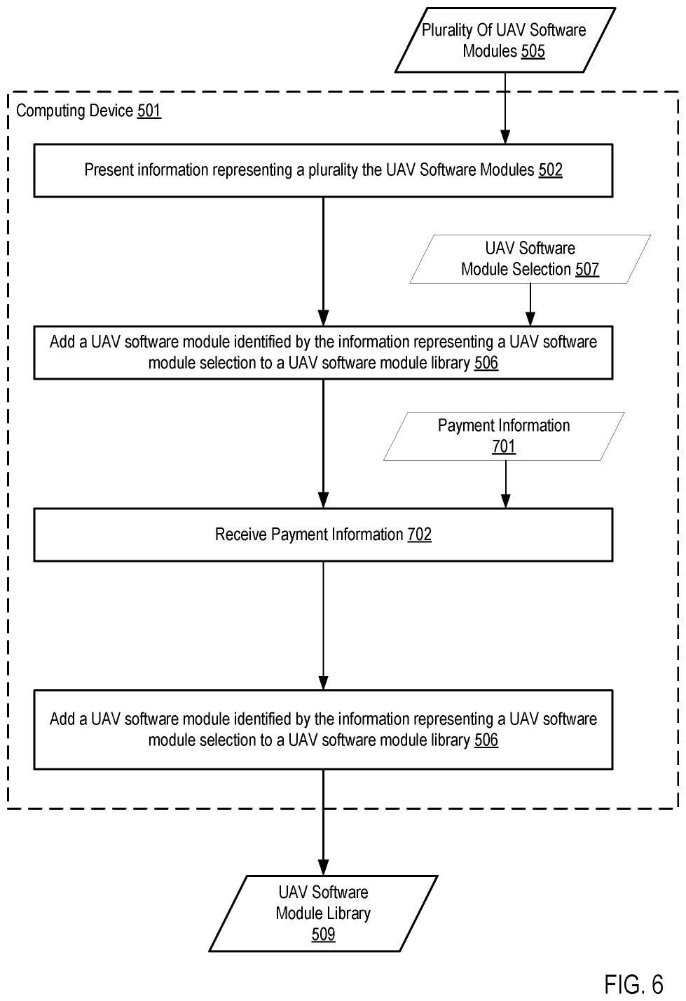

For further explanation, FIG. 6 sets forth a flow chart illustrating an exemplary method for UAV software module library management in accordance with at least one embodiment of the present disclosure. Like the exemplary method of FIG. 4, the exemplary method of FIG. 6 also includes presenting 502, by the computing system 501, information representing a plurality of UAV software modules 505; receiving 504, by the computing system 501, information representing a UAV software module selection 507 from the plurality of UAV software modules 505; and adding the UAV software module identified by the UAV software module selection 507 to a UAV software module library 509.

The exemplary method of FIG. 6 differs from the method of FIG. 4 in that the method of FIG. 6 further comprises receiving 702, by the computing system 501, payment information 701 prior to adding the UAV software module to the UAV software module library. In some examples, the receipt of payment information 701 may be carried out by the user device 120 of FIG. 1 or the server of 204 of FIG. 2. For example, the UAV software module library controller 135 of user device 120 may receive payment information 701 from a user to authorize the purchase of a UAV software module prior to the UAV software module library controller 135 adding the UAV software module to the UAV software module library. In another example, the UAV software module library controller 216 of server 202 may receive payment information 701 from a user interacting with a remote device such as user device 240 prior to adding the UAV software module to the UAV software module library. The payment information 701 may include information indicating that a payment has been authorized, such as a token or other method of confirming payment.

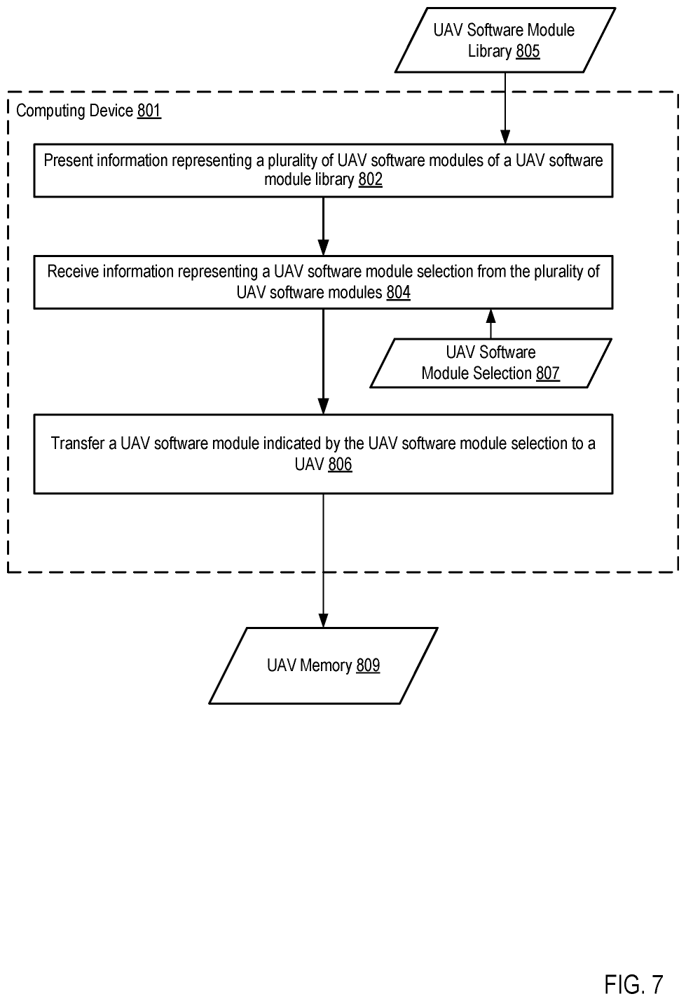

For further explanation, FIG. 7 sets forth a flow chart illustrating an exemplary method for UAV software module management in accordance with at least one embodiment of the present disclosure. The method of FIG. 7 includes a computing system 801 of a UAV module management system such as the user device 120 of FIG. 1 or server 202 of FIG. 2. The method includes presenting 802, by the computing system 801, information representing a plurality of UAV software modules of a UAV software module library 805; receiving 804, by the computing system 801, information representing a UAV software module selection 807 from the plurality of UAV software modules of the UAV software module library 805; and transferring the UAV software module identified by the UAV software module selection 807 to a UAV memory.

The computing system 801 may present 802 the information representing a plurality of UAV software modules of a UAV software module library 805 using the devices described in relation to FIG. 1 and FIG. 2. For example, referring to FIG. 1, the UAV software module controller 136, may cause the user device 120 to display or otherwise present information representing a plurality of UAV software modules of the UAV software module library 139 to a user. In some examples, the user device 120 may display a list, a detailed list, icons, or other visual representation of the plurality of UAV software modules of the UAV software module library 139 to the user. In other examples, the plurality of UAV software modules of the UAV software module library 139 may be presented to a user using audio descriptions of each UAV software module of the plurality of UAV software modules.

Referring to FIG. 2, in another example the UAV software module library controller 216 may cause the server 202 to present information representing the plurality of UAV software modules 212 to a user device 240. The user device 240 may then display or otherwise present the information representing the plurality of UAV software modules 212 to a user. The server 202 may present the information representing the plurality of UAV software modules 212 to the user device 240 by way of a communicative coupling between the server 202 and the user device 240, such as network 224.

The computing system 801 may receive 804 information representing a UAV software module selection 807 from the plurality of UAV software modules of the UAV software module library 805 using the devices described in relation to FIG. 1 and FIG. 2. For example, referring to FIG. 1, the UAV software module library controller 135 may cause the user device 120 to receive a selection of the UAV software module from the user interacting with the user device 120. The UAV software module selection 807 may be received by the user device 120 using common user interfaces, such as a touch input, keyboard input, voice recognition, mouse click, or other computer interaction.

In another example, referring to FIG. 2, the UAV software module library controller 216 may cause the server 202 to receive information indicating a UAV software module selection from the user device 240. The user device 240 may receive a UAV software module selection from a user interacting with the user device 240 using common user interfaces, such as a touch input, keyboard input, voice recognition, mouse click, or other computer interaction. The user device 240 may then send information representing the UAV software module selection 507 over network 224 for receipt by the server 202.

The computing system 501 may transfer 806 a UAV software module indicated by the information representing a UAV software module selection 807 to a UAV memory 809 using the devices described previously. In one example, referring to FIG. 1, the UAV software module library controller 135 may copy a UAV software module 103 identified by the UAV software module selection 807 from the UAV software module library 139 to the memory 106 of the UAV 102. With reference to FIG. 2, in another example, the UAV software module library controller 216 may copy the UAV software module 270 identified by the UAV software module selection 807 from the UAV software module library 214 to the UAV memory 266.

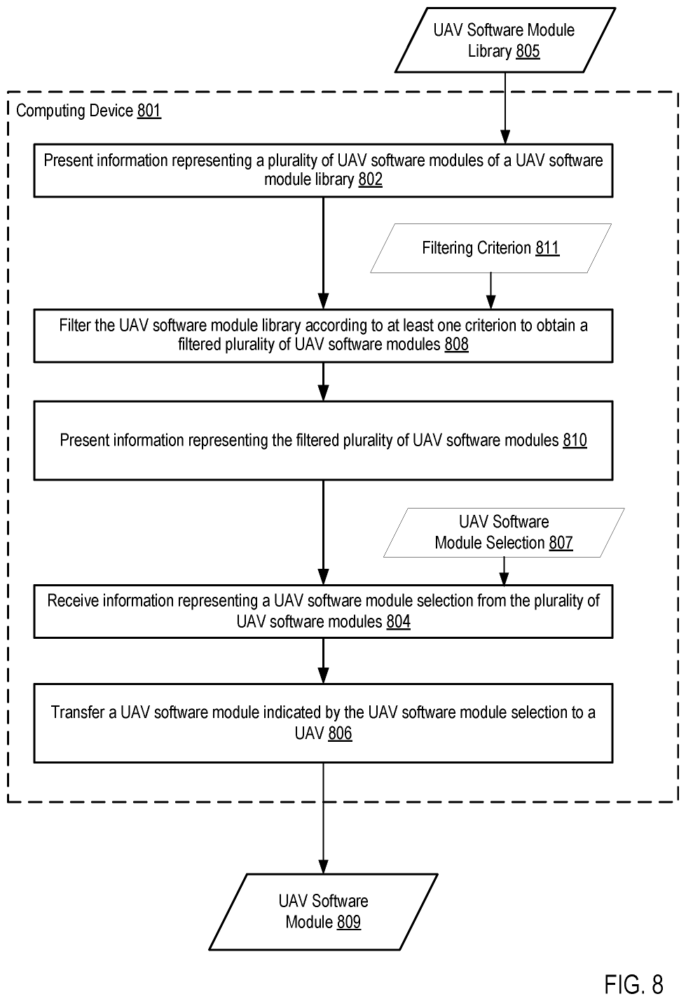

For further explanation, FIG. 8 sets forth a flow chart illustrating an exemplary method for UAV software module management in accordance with at least one embodiment of the present disclosure. Like the exemplary method of FIG. 7, the exemplary method of FIG. 8 also includes presenting 802, by the computing system 801, information representing a plurality of UAV software modules of a UAV software module library 805; receiving 804, by the computing system 801, information representing a UAV software module selection 807 from the plurality of UAV modules of the UAV software module library 805; and transferring the UAV software module identified by the UAV software module selection 807 to a UAV memory.

The exemplary method of FIG. 8 differs from the method of FIG. 7 in that the method of FIG. 8 further comprises filtering 808, by the computing system 801, the plurality of UAV software modules of the UAV software module library 805 according to at least one filtering criterion 811 and presenting 810, by the computing system 801, information representing the filtered plurality of UAV software modules. In some examples, the filtering 808 of the plurality of UAV software modules of the UAV software module library 805 according to at least one criterion may be carried out by the user device 120 of FIG. 1 or the server of 204 of FIG. 2. For example, a user may provide a filtering criterion 811 to the user device 120 by way of a user interface. The UAV software module controller 136 may then filter the plurality of UAV software modules of the UAV software module library 139 and cause the user device 120 to present the filtered plurality of UAV software modules to the user. In another example, a user may provide a filtering criterion to user device 240 which may then communicate with server 202 by way of network 224 to deliver the filtering criterion 811 to the server 202. The server 202 may then filter the plurality of UAV software modules of the UAV software module library 214 and present the filtered plurality of UAV software modules to the user device 240. In some examples, the filtering criterion may be one of the filtering criteria described previously.

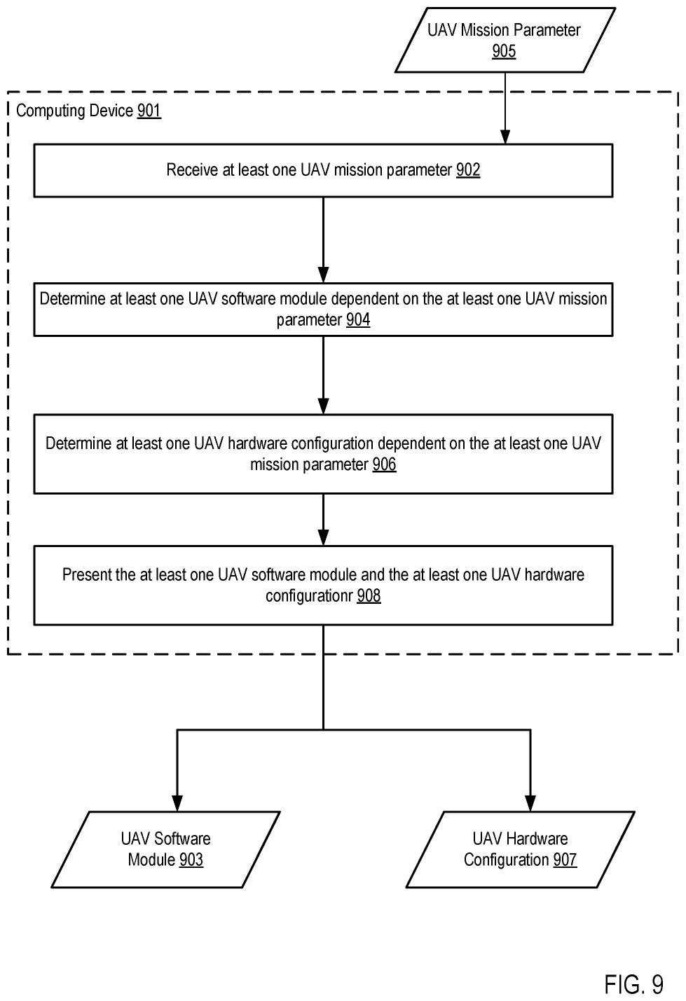

For further explanation, FIG. 9 sets forth a flow chart illustrating an exemplary method for UAV management in accordance with at least one embodiment of the present disclosure. The method of FIG. 9 includes a computing system 901 of a UAV module management system such as the user device 120 of FIG. 1 or server 202 of FIG. 2. The method includes receiving 902, by the computing system 901, at least one UAV mission parameter 905; determining 904, by the computing system 901, at least one UAV software module 903 dependent on the at least one UAV mission parameter 905; determining 906, by the computing system 901, at least one UAV hardware configuration 907 dependent on the at least one UAV mission parameter 905; and presenting 908, by the computing system 901, the at least one UAV software module 903 and the at least one UAV hardware configuration 907.

The computing system 901 may receive the at least one UAV mission parameter using the devices described in relation to FIG. 1 and FIG. 2. For example, referring to FIG. 1, the UAV configuration recommender 133 may cause the user device 120 to receive a UAV mission parameter 905. The UAV mission parameter 905 may be received from a user interacting with the user device 120 using common user interfaces using common user interfaces, such as a touch input, keyboard input, voice recognition, mouse click, or other computer interaction. For example, the user interface may present a list of possible mission types to a user and the user may select a mission type having associate mission parameters. Or a user may enter information describing their mission including mission parameters.

In another example, referring to FIG. 2, the UAV configuration recommender may cause the server 202 to receive at least one UAV mission parameter from the user device 240. The user device 240 may receive a UAV mission parameter 905 as described previously and send the mission parameter to the server 202 by way of network 224. In other examples, the UAV mission parameter may be received from a device other than the user device 240. For example, a user may select a mission type and the UAV mission parameter 905 associated with the UAV mission may be retrieved from a separate source.

UAV mission parameters are parameters that describe a UAV mission and may include parameters such as range, flight duration, object detection, object tracking, object counting, and responses to object detection. For example, a mission such as counting livestock may include parameters such as object counting, range, and flight duration.

The computing system 901 may determine 904 the at least one UAV software module dependent on the at least one UAV mission parameter 905 using the devices described in relation to FIG. 1 and FIG. 2. For example, referring to FIG. 1, the plurality of UAV software modules 145 or each UAV software modules of the UAV software module library 139 may have metadata associated with them that identify related mission types or contain other information about the respective UAV software module. The UAV configuration recommender 133 may then determine at least one UAV software module that matches or is related to the at least one UAV mission parameter 905 based on the metadata associated with each of the UAV software modules.

In another example, referring to FIG. 2, the plurality of UAV software modules 212 or each UAV software modules of the UAV software module library 214 may have metadata associated with the UAV software modules that identify related mission types or contain other information about each respective UAV software module. The UAV configuration recommender 220 may then determine at least one UAV software module that matches or is related to the at least one UAV mission parameter 905 based on the metadata associated with each of the UAV software modules.

The computing system 901 may determine 906 the at least one UAV hardware configuration 907 dependent on the at least one UAV mission parameter 905 using the devices described in relation to FIG. 1 and FIG. 2. For example, referring to FIG. 1, the user device 120, the server 140, or other data storage may contain a datastore of UAV hardware. The datastore may further store metadata including UAV hardware information such as related UAV hardware, related UAV software modules, UAV hardware capabilities, related UAV mission types, and other relevant hardware information. The UAV configuration recommender 133 may then determine at least one UAV hardware configuration that matches or is related to the at least one UAV mission parameter 905 based on the metadata associated with the UAV hardware. Furthermore, the UAV configuration recommender 133 may determine a UAV hardware configuration based on the UAV software modules determined previously.

In another example, referring to FIG. 2, the server 202, cloud storage 222, or other data storage may contain a datastore of UAV hardware. The datastore may further store metadata including UAV hardware information such as related UAV hardware, related UAV software modules, UAV hardware capabilities, related UAV mission types, and other relevant hardware information. The UAV configuration recommender 220 may then determine at least one UAV hardware configuration that matches or is related to the at least one UAV mission parameter 905 based on the metadata associated with the UAV hardware. Furthermore, the UAV configuration recommender 133 may determine a UAV hardware configuration 907 based on the UAV software modules determined previously. Examples of hardware configurations include, but are not limited to a UAV type, camera type, a sensor type, a payload capacity, a range, a propulsion type, a controller type, and a minimum performance specification.

Using the previous example of a livestock counting mission with UAV mission parameters comprising object counting, range, and flight duration, the computing system 901 may determine at least one software module that provides object counting and at least one hardware configuration that enables the object counting and has performance characteristics that meet or exceed the identified range and flight duration. For example, the computing system may recommend UAVs that have a camera or sensor type, or that may have a camera or sensor type added to the UAV to enable the object, that can fly for at least the identified range, and stay aloft for at least the identified flight duration.

Exemplary embodiments of the present invention are described largely in the context of a fully functional computer system for managing UAV software modules. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Hardware logic, including programmable logic for use with a programmable logic device (PLD) implementing all or part of the functionality previously described herein, may be designed using traditional manual methods or may be designed, captured, simulated, or documented electronically using various tools, such as Computer Aided Design (CAD) programs, a hardware description language (e.g., VHDL or Verilog), or a PLD programming language. Hardware logic may also be generated by a non-transitory computer readable medium storing instructions that, when executed by a processor, manage parameters of a semiconductor component, a cell, a library of components, or a library of cells in electronic design automation (EDA) software to generate a manufacturable design for an integrated circuit. In implementation, the various components described herein might be implemented as discrete components or the functions and features described can be shared in part or in total among one or more components. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:

1. A method for unmanned aerial vehicle (UAV) software module library management, comprising: presenting, by a computing system, information representing a plurality of UAV software modules, wherein each of the plurality of UAV software module enables at least one functionality of a UAV; receiving, from a user interacting with the computing system, information representing a UAV software module selection from the plurality of UAV software modules; and adding, by the computing system, a UAV software module identified by the information representing a UAV software module selection to a UAV software module library.

2. The method of statement 1, further comprising: filtering, by the computing system, the plurality of UAV software modules according to at least one criterion to obtain a filtered plurality of UAV software modules; and presenting, by the computing system, information representing the filtered plurality of UAV software modules.

3. The method of any of statements 1-2, wherein the at least one criterion comprises at least one of an identification of a UAV model, an identification of a desired UAV software module, an identification of a UAV mission objective, pricing information for at least one UAV software module of the plurality of UAV software modules, or a hardware specification of the UAV.

4. The method of any of statements 1-3, wherein the at least one functionality of the UAV comprises at least one of object detection, automated flight patterns, object tracking, object counting, or responses to object detection.

5. The method of any of statements 1-4, further comprising receiving payment information prior to adding the UAV software module to the UAV software module library.

6. The method of any of statements 1-5, wherein the UAV software module library is stored at the computing system.

7. The method of any of statements 1-6, wherein the UAV software module library is stored remotely from the computing system.

8. The method of any of statements 1-7, wherein the UAV software module library corresponds to a particular UAV.

9. The method of any of statements 1-8, wherein the UAV software module library corresponds to a particular user.

10. A method for unmanned aerial vehicle (UAV) software module management, the method including none or any of the statements 1-9 and the method comprising: presenting, by a computing system, information representing a plurality of UAV software modules of a UAV software module library, wherein the UAV software module library comprises at least one UAV software module that enables at least one functionality of a UAV; receiving, from a user interacting with the computing system, information representing a UAV software module selection from the plurality of UAV software modules of the UAV software module library; and transferring, by the computing system, a UAV software module indicated by the UAV software module selection to a UAV memory.

11. The method of any of the statements 1-10, further comprising: filtering, by the computing system, the UAV software module library according to at least one criterion to obtain a filtered plurality of UAV software modules; and presenting, by the computing system, information representing the filtered plurality of UAV software modules.

12. The method of any of the statements 1-11, wherein the at least one criterion comprises at least one of an identification of a UAV model, an identification of a desired UAV software module, an identification of a UAV mission objective, pricing information for the at least one UAV software module, or a hardware specification of the UAV.

13. The method of any of the statements 1-12, wherein the at least one functionality of the UAV comprises at least one of object detection, automated flight patterns, object tracking, object counting, or responses to object detection.

14. A method for unmanned aerial vehicle (UAV) recommendations, the method including none or any of the statements 1-13 and the method comprising: receiving, by a computing system, at least one UAV mission parameter; determining, by the computing system, at least one UAV software module dependent on the at least one UAV mission parameter, wherein the UAV software module enables at least one UAV functionality; determining, by the computing system, at least one UAV hardware configuration dependent on the at least one UAV mission parameter; and presenting, by the computing system, the at least one UAV software module and the at least one UAV hardware configuration.

15. The method of any of the statements 1-14, wherein the at least one UAV mission parameter includes at least one of range, object detection, object tracking, object counting, and responses to object detection.

16. The method of any of the statements 1-15, wherein the at least one UAV functionality comprises at least one of object detection, automated flight patterns, object tracking, object counting, or responses to object detection.

17. The method of any of the statements 1-16, wherein the at least one UAV hardware configuration comprises at least one of a camera type, a sensor type, a payload capacity, a range, a propulsion type, a controller type, and a minimum performance specification.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for unmanned aerial vehicle (UAV) software module library management, comprising:
presenting, by a computing system, information representing a plurality of UAV software modules, wherein each of the plurality of UAV software module enables at least one functionality of a UAV;
receiving, from a user interacting with the computing system, information representing a UAV software module selection from the plurality of UAV software modules; and
adding, by the computing system, a UAV software module identified by the information representing a UAV software module selection to a UAV software module library.

2. The method of claim 1, further comprising:
filtering, by the computing system, the plurality of UAV software modules according to at least one criterion to obtain a filtered plurality of UAV software modules; and
presenting, by the computing system, information representing the filtered plurality of UAV software modules.

3. The method of claim 2, wherein the at least one criterion comprises at least one of an identification of a UAV model, an identification of a desired UAV software module, an identification of a UAV mission objective, pricing information for at least one UAV software module of the plurality of UAV software modules, or a hardware specification of the UAV.

4. The method of claim 1, wherein the at least one functionality of the UAV comprises at least one of object detection, automated flight patterns, object tracking, object counting, or responses to object detection.

5. The method of claim 1, further comprising receiving payment information prior to adding the UAV software module to the UAV software module library.

6. The method of claim 1, wherein the UAV software module library is stored at the computing system.

7. The method of claim 1, wherein the UAV software module library is stored remotely from the computing system.

8. The method of claim 1, wherein the UAV software module library corresponds to a particular UAV.

9. The method of claim 1, wherein the UAV software module library corresponds to a particular user.

10. A method for unmanned aerial vehicle (UAV) software module management, comprising:
presenting, by a computing system, information representing a plurality of UAV software modules of a UAV software module library, wherein the UAV software module library comprises at least one UAV software module that enables at least one functionality of a UAV;
receiving, from a user interacting with the computing system, information representing a UAV software module selection from the plurality of UAV software modules of the UAV software module library; and
transferring, by the computing system, a UAV software module indicated by the UAV software module selection to a UAV memory.

11. The method of claim 10, further comprising:
filtering, by the computing system, the UAV software module library according to at least one criterion to obtain a filtered plurality of UAV software modules; and
presenting, by the computing system, information representing the filtered plurality of UAV software modules.

12. The method of claim 11, wherein the at least one criterion comprises at least one of an identification of a UAV model, an identification of a desired UAV software module, an identification of a UAV mission objective, pricing information for the at least one UAV software module, or a hardware specification of the UAV.

13. The method of claim 10, wherein the at least one functionality of the UAV comprises at least one of object detection, automated flight patterns, object tracking, object counting, or responses to object detection.

14. A method for unmanned aerial vehicle (UAV) recommendations, comprising:
receiving, by a computing system, at least one UAV mission parameter;
determining, by the computing system, at least one UAV software module dependent on the at least one UAV mission parameter, wherein the UAV software module enables at least one UAV functionality;
determining, by the computing system, at least one UAV hardware configuration dependent on the at least one UAV mission parameter; and
presenting, by the computing system, the at least one UAV software module and the at least one UAV hardware configuration.

15. The method of claim 14, wherein the at least one UAV mission parameter includes at least one of range, object detection, object tracking, object counting, and responses to object detection.

16. The method of claim 14, wherein the at least one UAV functionality comprises at least one of object detection, automated flight patterns, object tracking, object counting, or responses to object detection.

17. The method of claim 14, wherein the at least one UAV hardware configuration comprises at least one of a camera type, a sensor type, a payload capacity, a range, a propulsion type, a controller type, and a minimum performance specification.
